(19) United States
(12) Patent Application Publication
(10) Pub. No.: US 2026/0178637 A1
(43) Pub. Date: Jun. 25, 2026

(54) SYSTEMS AND METHODS FOR DETERMINING NON-COMPLIANCE FROM AN INITIAL ASSESSMENT INPUT IN NATURAL LANGUAGE

(71) Applicant: NEUTRALAIZ INC., Windsor (CA)

(72) Inventors: Andrew KELLY, Drayton (CA); James MORFEA, Whitby (CA); Stalin VASQUEZ, Windsor (CA)

(21) Appl. No.: 19/388,201

(22) Filed: Nov. 13, 2025

Related U.S. Application Data
(60) Provisional application No. 63/736,051, filed on Dec. 19, 2024.

(51) Int. Cl. G06F 16/334; G06F 16/335; G06F 16/34; G06F 16/387; G06F 40/30

(52) U.S. Cl. CPC G06F 16/3347; G06F 16/337; G06F 16/345; G06F 16/387; G06F 40/30

(57) ABSTRACT

A system and method for automatically determining non-compliance from an initial assessment input describing an event in a natural language are disclosed. The method involves applying an event assessment data model to the initial assessment input to identify one or more actions observed and to derive one or more behaviors related to the observed one or more actions; applying a behavioral assessment data model to select a set of misconducts from the one or more actions, the set of misconducts comprising the one or more actions likely to be non-compliant with a set of rules; identifying one or more alternative misconducts semantically similar to the set of misconducts within a context of the event associated with the one or more behaviors; and providing one or more rules violated by the set of misconducts and the one or more alternative misconducts.

### CROSS-REFERENCE TO RELATED APPLICATION(S)

This application claims the benefit of U.S. Provisional Patent Application No. 63/736,051 filed Dec. 19, 2024 entitled “SYSTEMS AND METHODS FOR DETERMINING NON-COMPLIANCE FROM AN INITIAL ASSESSMENT INPUT IN NATURAL LANGUAGE”. The contents of U.S. Provisional Patent Application No. 63/736,051 is hereby incorporated herein by reference in its entirety.

### FIELD

The described embodiments relate to systems and methods for determining non-compliance from an initial assessment input provided in a natural language format. In some embodiments, the non-compliance can comprise a legal infraction that is determined from an enforcement assessment input provided in a natural language format from an enforcement officer.

### BACKGROUND

Various individuals, such as, but not limited to legal practitioners, compliance professionals, and regulatory agents, may need to determine whether any non-compliance of certain regulations or rules may have taken place. Oftentimes, the individuals are required to recognize such non-compliance fairly quickly. Enforcement officers, for example, derive their authority from the laws they are entrusted to uphold. They engage with the laws daily, including for example, when investigating suspected violations, interacting with the public, and documenting reports. To this end, enforcement officers are often required to quickly and accurately detect behaviors related to legal infractions and to identify relevant laws shortly thereafter. It is important for an enforcement officer to recite the laws accurately, accounting for various factors such as legal language, jurisdictional differences, and updates and amendments to legislation. Other examples can include company codes of conduct and/or other corporate policies, airport regulations, even covenants or representations and warranties in contractual agreements.

However, in many such situations, there is an urgency to actions required of the various individuals, such as enforcement officers. The environment surrounding the violations observed is typically chaotic, or stressful, and often associated with unexpected behaviors and reactions. As a result, it can be difficult for enforcement officers to accurately identify all relevant laws in real-time or when recalling an event to prepare reports.

### SUMMARY

The various embodiments described herein generally relate to systems and methods for determining non-compliance from an initial assessment input describing an event in a natural language format. In some embodiments, the non-compliance can include a legal infraction that is determined from an enforcement assessment input provided in a natural language format from an enforcement officer.

In accordance with an example embodiment, there is provided a method for automatically determining non-compliance from an initial assessment input describing an event in a natural language format. The method includes operating a processor to apply an event assessment data model to the initial assessment input to identify one or more actions observed and to derive one or more behaviors related to the observed one or more actions; apply a behavioral assessment data model to select a set of misconducts from the one or more actions, the set of misconducts comprising the one or more actions likely to be non-compliant with a set of rules; identify one or more alternative misconducts semantically similar to the set of misconducts and the one or more behaviors within a context of the event; and provide one or more rules violated by the set of misconducts and the one or more alternative misconducts.

In some embodiments, operating the processor includes determining one or more legal infractions from the initial assessment input and the set of misconducts including one or more actions likely to infringe a law.

In some embodiments, operating the processor includes identifying one or more alternative misconducts legally similar to the set of misconducts within a context of the event associated with the one or more behaviors.

In some embodiments, operating the processor to apply the event assessment data model includes identifying, from the initial assessment input, a regional dialect comprising one or more geographically-specific phrases; and assessing the initial assessment input by considering the regional dialect to determine one or more semantic actions of the identified one or more actions and to derive one or more behaviors.

In some embodiments, operating the processor to apply the event assessment data model includes generating an unbiased initial assessment input, the unbiased initial assessment input absent one or more profiling descriptors.

In some embodiments, operating the processor to apply the behavioral assessment data model includes generating a search vector comprising the one or more actions likely to be non-compliant with a set of rules and the one or more derived behaviors.

In some embodiments, operating the processor to apply the behavioral assessment data model includes evaluating the one or more actions likely to be non-compliant with a set of rules to determine an infringement confidence level.

In some embodiments, operating the processor to apply the behavioral assessment data model includes identifying from a database one or more regulatory sources associated with the one or more actions and filtering one or more sections from the one or more regulatory sources based on the one or more behaviors.

In some embodiments, operating the processor to provide one or more rules includes receiving a user profile, the user profile comprising at least a geographical location; and filtering the one or more rules based on the user profile to provide one or more localized rules associated with the geographical location.

In some embodiments, operating the processor to provide one or more rules includes identifying one or more organizational components of the one or more rules; generating a summarized description of the one or more rules; and determining a relevance level for the one or more rules based on the one or more behaviors within a context of the event.

In some embodiments, operating the processor to provide one or more rules includes displaying the one or more rules on a graphical interface.

In accordance with another example embodiment, there is provided an assessment system for automatically determining non-compliance from an initial assessment input describing an event in a natural language format. The system includes a data storage including an event assessment data model operable for identifying one or more actions from an input in the natural language format, and a behavioral assessment data model operable for identifying misconducts from the one or more actions; and a processor in communication with the data storage, the processor being operable to: apply the event assessment data model to the initial assessment input to identify one or more actions observed and to derive one or more behaviors related to the observed one or more actions; apply the behavioral assessment data model to select a set of misconducts from the one or more actions, the set of misconducts comprising the one or more actions likely to be non-compliant with a set of rules; identify one or more alternative misconducts semantically similar to the set of misconducts and the one or more behaviors within a context of the event; and provide one or more rules violated by the set of misconducts and the one or more alternative misconducts.

In some embodiments, the processor is operable to determine one or more legal infractions from the initial assessment input and the set of misconducts including one or more actions likely to infringe a law.

In some embodiments, the processor is operable to identify one or more alternative misconducts legally similar to the set of misconducts within a context of the event associated with the one or more behaviors.

In some embodiments, the processor is operable to identify, from the initial assessment input, a regional dialect comprising one or more geographically-specific phrases; and assess the initial assessment input by considering the regional dialect to determine one or more semantic actions of the identified one or more actions and to derive one or more behaviors.

In some embodiments, the processor is operable to generate an unbiased initial assessment input, the unbiased initial assessment input absent one or more profiling descriptors.

In some embodiments, the processor is operable to generate a search vector comprising the one or more actions likely to be non-compliant with a set of rules and the one or more derived behaviors.

In some embodiments, the processor is operable to evaluate one or more actions likely to be non-compliant with a set of rules to determine an infringement confidence level.

In some embodiments, the processor is operable to identify from a database one or more regulatory sources associated with the one or more actions; and filter one or more sections from the one or more regulatory sources based on the one or more behaviors.

In some embodiments, the processor is operable to receive a user profile, the user profile comprising at least a geographical location; and filter the one or more rules based on the user profile to provide one or more localized rules associated with the geographical location.

In some embodiments, the processor is operable to identify one or more organizational components of the one or more rules; generate a summarized description of the one or more rules; and determine a relevance level for the one or more rules based on the one or more behaviors within a context of the event.

In some embodiments, the processor is operable to display the one or more rules on a graphical user interface.

### BRIEF DESCRIPTION OF THE DRAWINGS

Several embodiments will now be described in detail with reference to the drawings, in which:

FIG. 1 is a block diagram of components interacting with an assessment system in accordance with an example embodiment;

FIG. 2 is a flowchart of an example embodiment of a method for automatically determining non-compliance from an initial assessment input describing an event in a natural language format, in accordance with an example embodiment;

FIG. 3A is an illustration of an example user interface displaying an example dashboard, in accordance with an example embodiment;

FIG. 3B is an illustration of an example user interface displaying another example dashboard, in accordance with an example embodiment; and

FIG. 3C is an illustration of an example user interface displaying another example dashboard, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Various individuals, such as, but not limited to, legal practitioners, compliance professionals, and regulatory agents, rely on knowledge and training to identify appropriate regulations or rules that may apply to a given situation. Enforcement officers, for example, are trained to recognize legal infractions of laws. When an enforcement officer witnesses an event, they must quickly determine whether the observed actions are likely to lead to an infraction of a law. This process can include analyzing the witnessed event, identifying actions and behaviors that may lead to an infraction of a law, searching legal databases, and using discretion to select laws that are relevant to the witnessed event. This process can be inexact and incomplete, as the process generally relies on the experience and intuition of the officer performing the analysis search. The scope of searched laws can be limited to the officer's familiarity with the legislation.

Although there are tools and resources available that can assist enforcement officers in real-time, there can be limitations to such tools. These tools can be useful when enforcement officers need to quickly search a known law and recall details on that law. For example, an enforcement officer may conduct a traffic stop after witnessing a civilian commit a potential violation of the law, such as running a stop sign. The enforcement officer may already know the law violated but needs assistance identifying the exact language. Existing tools can assist with identifying and offering guidance on the identified law.

However, there can be instances where an enforcement officer intuitively knows that there was a legal violation, or likely multiple legal violations, but is unable to quickly articulate to the civilian (or another third party, including other officers) which laws they have been suspected of violating. For example, an officer may conduct a traffic stop to cite a vehicle for improper material (i.e., illegal window tint) but miss that the driver turned right on a red light (which may be illegal in some jurisdictions). Existing tools, if the exact details of a law is not provided within the search input, are unable to provide enforcement officers with immediate guidance.

Further, laws may have legal nuances that an officer may not be aware of. That is, even though enforcement officers are well-trained to identify and handle legal infractions, they are not legally trained to appreciate all specific nuances between different laws. Overlapping legal provisions may address the same type of infraction but may be applied differently depending on the context of the situation. In some cases, it may be more appropriate to apply one legal provision over another. For example, a vehicle may be pulled over by an officer for speeding in a construction zone. The officer may cite the driver under the baseline provision for operating a vehicle above the posted speed limit but miss that the fine may be more severe since the violation occurred in a construction zone.

Laws can also be amended, repealed, revised, or consolidated depending on changes to social and technological needs. For example, with the advent of self-driving vehicles, legislation regulating their use is routinely updated. Officers must continually refresh their knowledge of such legislation to ensure they are aptly applying the law under the correct standards. As another example, firearm regulation is continuously changing to include or exclude many different firearm models and accessories, depending on the state of the law in that area.

Laws related to, for example, traffic and motor vehicles, firearms, and alcohol and drug control may vary based on jurisdiction. For example, different types of drugs may be illegal in some jurisdictions but legal in others.

Accordingly, it is important for officers to be able to holistically assess incidents in the field and be equipped with knowledge of how to apply current and relevant legislation to their situation. Similarly, other individuals can be required to be knowledgeable and be able to recognize relevant rules that may be applicable. Such examples can include, but not limited to, company codes of conduct and/or other corporate policies, airport regulations, even covenants or representations and warranties in contractual agreements. The disclosed methods and systems can similarly be used for identifying the relevant rules.

The various embodiments described herein generally relate to assessment systems involving one or more data models for analyzing an observed event (and methods for applying one or more data models for analyzing an observed event). The methods involve operating a processor to apply an event assessment data model to an assessment input to identify one or more actions observed. The event assessment model can also be applied to derive one or more behaviors related to the observed one or more actions. A behavioral assessment data model can be applied to select a set of misconducts from the one or more actions. The set of misconducts can include the one or more actions likely to be non-compliant with a set of rules. The processor can be operated to identify one or more alternative misconducts semantically similar to the set of misconducts within a context of the event associated with the one or more behaviors. The processor can be operated to provide one or more rules violated by the set of misconducts and the one or more alternative misconducts.

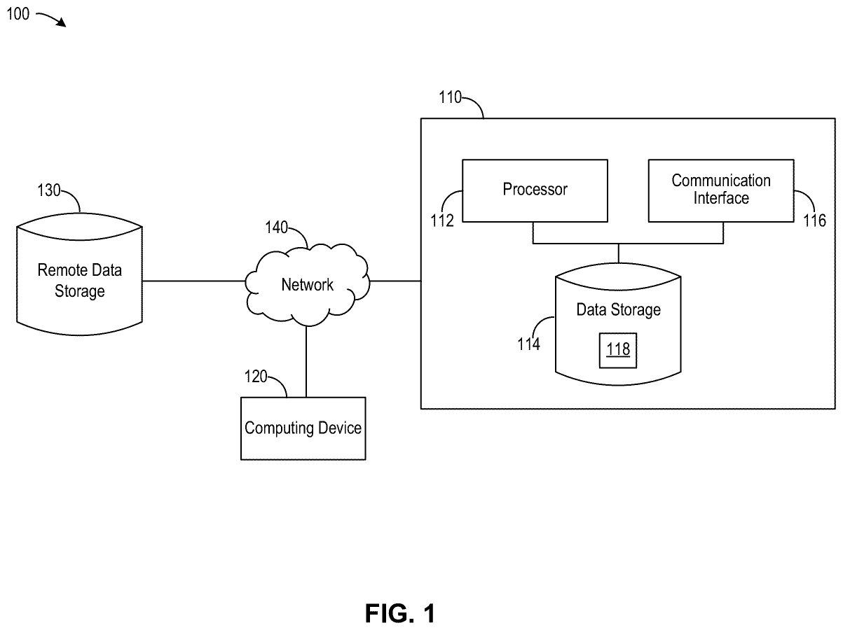

Reference is first made to FIG. 1, which illustrates a block diagram 100 of components interacting with an assessment system 110. As shown in FIG. 1, the assessment system 110 can be in communication with a computing device 120 and a remote data storage 130 via a network 140.

The assessment system 110 includes a processor 112, a data storage 114, and a communication interface 116. The processor 112, the data storage 114, and the communication interface 116 may be implemented in software or hardware, or a combination of software and hardware. The processor 112, the data storage 114, and the communication interface 116 can be combined into fewer number of components or may be separated into further components. The assessment system 110 may, in some embodiments, be split into multiple computing systems that may be distributed over a wide geographic area and connected via the network 140. The assessment system 110 can also operate offline and isolated from the network 140. The assessment system 110 can be adapted to provide data models with varying degrees of processing power. For example, data models with greater processing power may be provided for users subscribed to a higher tier plan. As another example, data models with lesser processing power may be provided for users operating a user device with lesser computational capabilities (e.g., a phone may have lesser computational capabilities compared to a desktop computer).

The processor 112 is configured to control the operation of the assessment system 110. The processor 112 may be any suitable processors, controllers or digital signal processors that can provide sufficient processing power depending on the configuration, purposes and requirements of the assessment system 110. In some embodiments, the processor 112 can include more than one processor with each processor being configured to perform different dedicated tasks. For example, the processor 112 can identify one or more misconducts that can include one or more actions likely to be non-compliant with a set of rules. The processor can also provide one or more rules violated by the set of misconducts. The processor 112 can further, for example, display one or more rules on a graphical interface.

The data storage 114 can include RAM, ROM, one or more hard drives, one or more flash drives or some other suitable data storage elements such as disk drives, etc. For example, the data storage 114 can store one or more user profiles that are uploaded to the assessment system 110. In some embodiments, the initial assessment input is stored on data storage 114 temporarily (e.g., the initial assessment input may be deleted from data storage 114 following execution of the non-compliance determination process). The data storage 114 can store initial information extracted from the rule, such as but not limited to an titles, headings, subheadings, and enumerated lists. The data storage 114 can also store one or more databases which can be searched by the assessment system 110 to provide rules.

The data storage 114 can also store various data models 118 that are used in the non-compliance identification process. For example, the data storage 114 can store an event assessment data model which can be operated by the processor 112 to identify one or more actions observed and to derive one or more behaviors related to the observed one or more actions. In another example, the data storage 114 can also store a behavioral assessment data model which can be operated by the processor 112 to select a set of misconducts from the one or more actions. The set of misconducts may include one or more actions that are likely to be non-compliant with a set of rules. Other data models 118 can be used by the assessment system 110.

The communication interface 116 may be any interface that enables the assessment system 110 to communicate with other devices and systems. The communication interface 116 may also include at least one of an Internet, Local Area Network (LAN), Ethernet, Firewire, modem or digital subscriber line connection. Various combinations of these elements may be incorporated within the communication interface 116. For example, the communication interface 116 may receive input from various input devices, such as a mouse, a keyboard, a touch screen, a thumbwheel, a track-pad, a track-ball, a card-reader, voice recognition software and the like depending on the requirements and implementation of the assessment system 110.

The remote data storage 130 can include one or more processors with computing processing abilities and memory such as a database(s) or file system(s). Although only one remote data storage 130 is shown for ease of exposition, there may be multiple remote data storage 130 distributed over a wide geographic area and connected via network 140. The remote data storage 130 can be used to store back-up data in some embodiments, and/or data less frequently accessed by the assessment system 110. For example, the remote data storage 130 can store data related to a user profile.

The computing device 120 may be any networked device operable to connect to the network 140. A networked device is a device capable of communicating with other devices through a network such as the network 140. A networked device may couple to the network 140 through a wired or wireless connection. These computing devices 120 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

Although only one computing device 120 is shown in FIG. 1, it will be understood that more than one computing device 120 can communicate with the assessment system 110 at any one time. The computing device 120 can be used by a user of the assessment system 110. In some embodiments, a connection request initiated from the computing device 120 may be initiated from a web browser and directed at the browser-based communications application on the assessment system 110. In some embodiments, computing device 120 includes separate computing devices for different users interacting with the assessment system 110. For example, the different users can include, but are not limited to, a regulatory agent working in the field inputting an initial assessment input and receiving recommendations on rules related to the initial assessment input, an officer preparing a report in response to an incident, and/or an individual conducting research for educational purposes. The computing device 120 can include a user interface that allows a user to interact with the assessment system 110.

The network 140 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the assessment system 110, the computing device 120, and the remote data storage 130.

One or more artificial intelligence models can be accessed by the assessment system 110 via the network 140. For example, in some embodiments, the one or more artificial intelligence models can be stored on remote data storage 130. In some embodiments, the one or more artificial intelligence models can be local to the assessment system 110 (e.g., stored on data storage 114). In some embodiments, the one or more artificial intelligence models includes one or more generative artificial intelligence models such as a large language model (LLM). In some embodiments, the one or more artificial intelligence models include one or more externally provided and/or externally available models. For example, in some embodiments, the one or more artificial intelligence models include one or more third-party models. In some embodiments, the one or more artificial intelligence models are trained to receive a plain language prompt and output a plain language response. In some embodiments, other types of artificial intelligence models are used. In some embodiments, one or more artificial intelligence models may be stored and run locally on the assessment system 110.

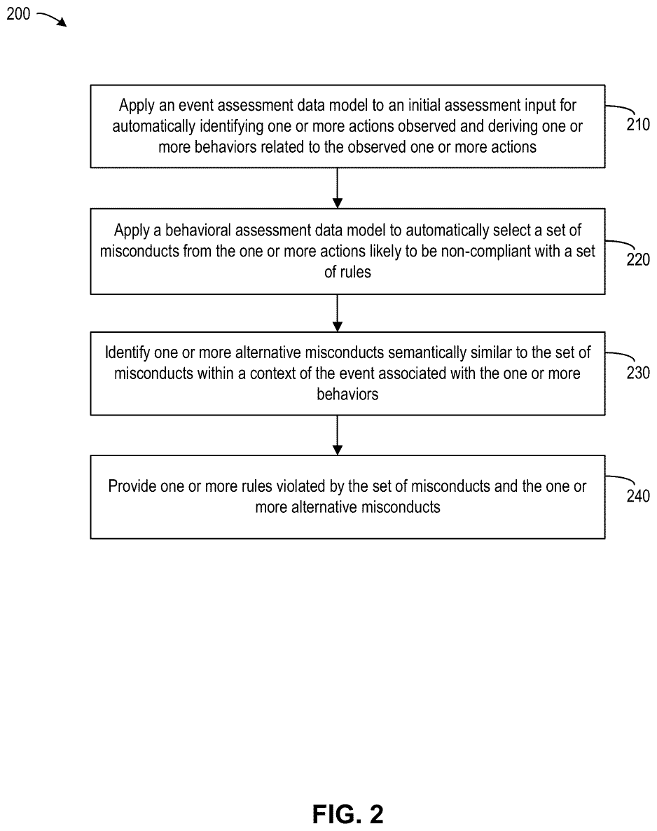

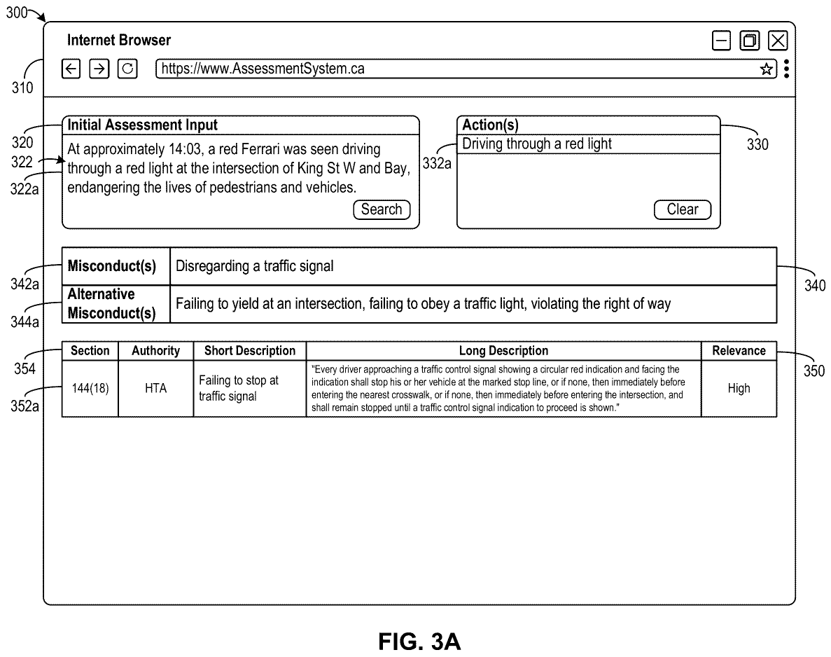

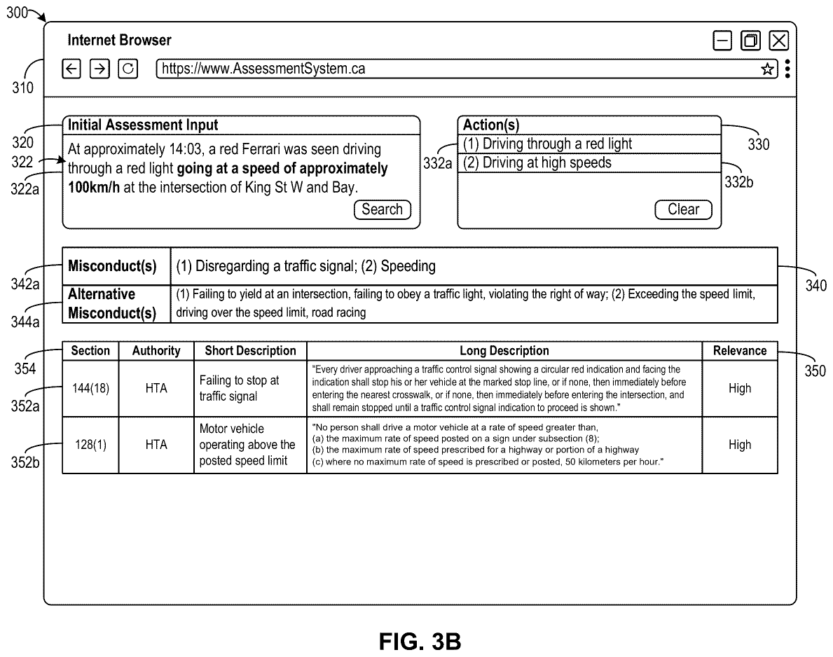

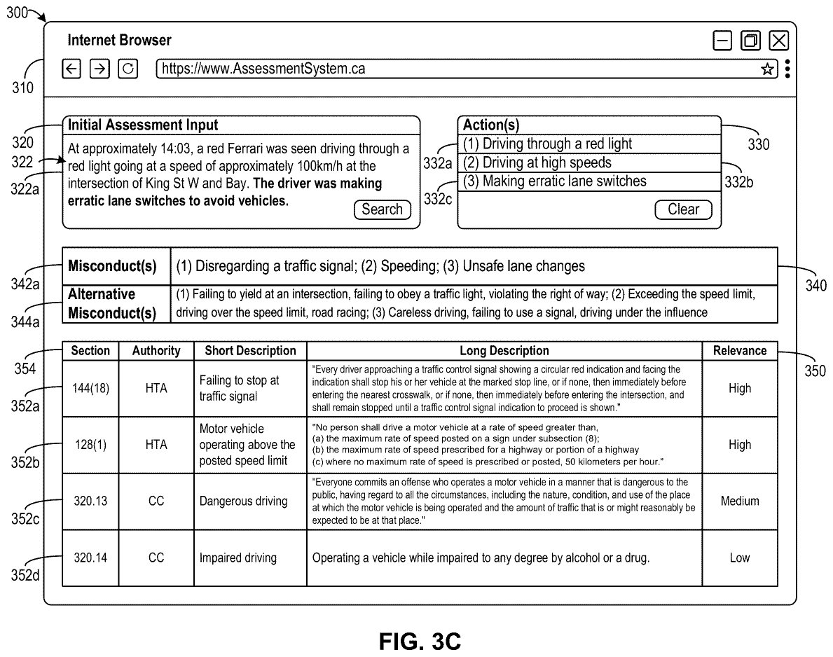

Referring now to FIG. 2, shown therein is a flowchart of an example method 200 for automatically determining non-compliance from an initial assessment input describing an event in a natural language format. To illustrate the method 200, reference will be made to FIGS. 3A to 3C.

At 210, the processor 112 applies an event assessment data model to an initial assessment input to automatically identify one or more actions observed and to automatically derive one or more behaviors related to the observed one or more actions.

Referring to FIG. 3A, shown therein is an example user interface 300 displaying an example dashboard 310. Although the example user interface 300 shown in FIG. 3 is displayed as a webpage in web browser, it should be understood that the assessment system 110 can be implemented using other suitable implementations. For example, the assessment system 110 can be implemented using a desktop application or a mobile application.

As shown in FIG. 3A, the dashboard 310 can include an initial assessment input field 320, an action field 330, a misconduct field 340, and a rules field 350. Other fields may be included, or some of the illustrated fields may be removed.

The initial assessment input field 320 prompts a user to provide an initial assessment input 322. The initial assessment input 322 can be in a natural language format such as plain text. For example, the initial assessment input 322 can include a narrative description of an incident, as shown in FIG. 3A. It may be that the initial assessment input 322 can be provided by other individuals, as described.

In some embodiments, the initial assessment input may be a multimedia format that can be converted into a natural language format. For example, the initial assessment input may include an audio recording of a dialogue exchange between an enforcement officer and a civilian, subsequently translated to a natural language format using text-to-speech software. As another example, the initial assessment input may include an image of handwritten notes of an incident documented by an enforcement officer in the field, subsequently converted to a natural language format using optical character recognition (OCR) software or artificial intelligence vision models used for extracting image features or document layouts.

In some embodiments, the initial assessment input 322 is temporarily stored in the data storage 114. The initial assessment system 110 can receive further edits to the initial assessment input 322 that refines the description and/or adds additional information. The edits provided can trigger the assessment system 110 (e.g., to apply the event assessment data model again) to identify additional actions in the action field 330.

The action field 330 provides one or more actions 332 determined by the assessment system 110 that are observed from the initial assessment input 322. Actions can be determined by the processor 112 by applying the event assessment data model. For example, the event assessment data model can be applied to the initial assessment input 322a to identify the action 332a of “driving through a red light.” As another example, as shown in FIG. 3B, the event assessment data model can be applied to initial assessment input 322b to identify the action 332b of “driving at high speeds.”

The event assessment data model can also be applied to the initial assessment input 322 to derive one or more behaviors related to the observed one or more actions 332. Behaviors characterize the nature of how the action was performed. For example, the event assessment data model may derive a behavior defined as “reckless” from the phrase, “endangering the lives of pedestrians and vehicles”, as described in the initial assessment input 322a. As another example, referring to FIG. 3C, the event assessment data model may derive a behavior defined as “erratic” from the phrase, “making erratic lane switches” as described in initial assessment input 322c.

In some embodiments, the event assessment data model can be applied to the initial assessment input 322 to identify a regional dialect including one or more geographically specific phrases. For example, the action 332a “driving through a red light” can be identified by the event assessment data model from the phrase “drove through a red light” in the initial assessment input 322a. In some cases, an alternative regional dialect may be used to describe the same observed scenario. For example, instead of using the phrase “driving through a red light”, which may be commonly used in North America, a user located in the United Kingdom may use the geographically specific phrase (i.e., slang) “jumped a red light”; or, a user located in Australia may use the geographically-specific phrase “shot a red light” to describe the same action.

The event assessment data model can use the identified geographically specific phrases to identify a regional dialect and assess the initial assessment input 322 by considering the regional dialect to determine one or more semantic actions of the identified on or more actions. For example, the phrase “jumped the red light” may be used in the initial assessment input 322. As a result, the event assessment data model may identify a United Kingdom regional dialect. By considering the identified regional dialect, the event assessment data model can interpret the phrase “jumped the red light” to not indicate that a vehicle physically leaped over a red light. Instead, by considering the identified regional dialect, the event assessment data model can interpret the phrase “jumped the red light” to indicate that the vehicle performed the action of driving through a traffic light.

The event assessment data model can determine one or more semantic actions based on the observed action 332a of “driving through a red light”. Semantic actions can be other related geographically specific phrases. Semantic actions can also be actions the event assessment data model considers as having the same meaning as the observed action. For example, a semantic action to “driving through a red light” as described by action 332a may be “ignoring visual traffic signals” or “disobeying a stop command”.

In some embodiments, the event assessment data model can generate an unbiased initial assessment input. The unbiased initial assessment input removes profiling descriptors such as the age, gender, and race of a suspect. Removing profiling descriptors can accelerate the operation of the processor 112 by eliminating extraneous information that does not contribute to the likelihood that an observed action will be non-compliant with a set of rules. In other embodiments, the event assessment data model may retain profiling descriptors when they are relevant to the likelihood that an observed action will be non-compliant with a set of rules. For example, rules related to underage consumption of alcohol may require profiling descriptors related to age.

Referring to FIG. 2, at 220, the processor 112 applies a behavioral assessment data model to select a set of misconducts 342 from the one or more actions 332.

The set of misconducts 342 can include one or more actions likely to be non-compliant with a set of rules. A set of rules can be, for example, but not limited to, legislation, company codes of conduct and/or other corporate policies, airport regulations, and covenants or representations and warranties in contractual agreements.

Referring to FIG. 3A, the misconduct field 340 provides a set of misconducts 342. The behavioral assessment data model can select a set of misconducts 342 from the one or more actions 332 provided in the action field 330. For example, the behavioral assessment data model may select the misconduct 342 “disregarding a traffic signal” from action 332a “driving through a red light” if the behavioral assessment data model determines the action 332a is likely to be non-compliant with a set of rules.

In some cases, the behavioral assessment data model can select misconducts that are an abstracted variant of the observed one or more actions. For example, the misconduct 342a “disregarding a traffic signal” is a more abstracted variant that the behavioral assessment data model determines is more likely to be non-compliant with a set of rules than the action 332a “driving through a red light”.

In some embodiments, applying the behavioral assessment data model can include generating a search vector including one or more actions likely to be non-compliant with a set of rules and the one or more derived behaviors. The search vector can be used to search and filter information within a database, for example, but not limited to, a database containing actions that are likely to be non-compliant with a set of rules

The search vector can be applied recursively to a number of layers as the dataset expands. The search vector can be used to filter rules that likely do not apply to a derived behavior. For example, if the initial assessment input relates to a suspect speeding, rules related to fishing and hunting likely do not apply.

In some embodiments, applying the behavioral assessment data model can include identifying from a database one or more regulatory sources associated with the one or more actions. For example, the database may contain regulatory sources such as, but not limited to, statutes, regulations, and codes of conduct. For example, if the initial assessment input relates to a suspect operating a motor vehicle, the behavioral assessment data model may identify the Highway Traffic Act from the database as a regulatory source associated with operating a motor vehicle.

The behavioral assessment data model can filter one or more sections from the one or more regulatory sources based on the one or more behaviors. For example, if the initial assessment input relates to a suspect operating a motor with improper material, the behavioral assessment model can filter out sections of the Highway Traffic Act unrelated to operating a motor vehicle with improper material, such as for example, sections related to motor vehicle speed or operating a motor vehicle under the influence.

In some embodiments, applying the behavioral assessment data model can include evaluating one or more actions likely to be non-compliant with a set of rules to determine an infringement confidence level. The infringement confidence level indicates how likely an observed action is to be non-compliant with a set of rules. The infringement confidence level may be based on semantic similarities between the identified one or more actions and a rule that the action is likely to be non-compliant with. For example, the action 332a “driving through a red light” may mirror language provided in a rule related to obeying traffic signals and the behavioral assessment data model may determine that the action 332a has a high infringement confidence level.

Referring to FIG. 2, at 230, the processor 112 identifies one or more alternative misconducts 344 semantically similar to the set of misconducts 342 within a context of the event associated with the one or more behaviors.

Referring to FIG. 3A, the misconduct field 340 provides one or more alternative misconducts 344 that are semantically similar to the set of misconducts 342 with consideration of the identified behaviors within a context of the event described by the initial assessment input 322. For example, the processor 112 may identify “failing to yield at an intersection, failing to obey a traffic light, and violating the right of way” as alternative misconducts 344a which are semantically similar to the misconduct 342a of “disregarding a traffic signal”. The processor 112 can determine that the description of “traffic light” disregards any violation related to a highway or at a stop sign, for example, given that the context is an intersection controlled by traffic lights. The semantically similar misconducts cannot simply be any similar actions but requires that those misconducts be within a similar context of the described event.

Semantically similar alternative misconducts can include misconducts that share similar characteristics or principles as the selected misconduct within the context of the event. The similarities between a misconduct and an alternative misconduct may lead to a similar interpretation. For example, the alternative misconduct 344a “failing to yield at an intersection” may be interpreted as having the same consequences as, and therefore semantically similar to, the misconduct 342a “disregarding a traffic signal”. As another example, referring to FIG. 3C, the alternative misconduct 344c “careless driving” may be interpreted as having the same level of negligence as, and therefore semantically similar to, the misconduct 342c “unsafe lane changes”.

Semantically similar alternative misconducts can also include misconducts which broaden the scope of interpretation of the misconduct selected by the behavioral assessment data model. Nuances between a misconduct and an alternative misconduct may capture a larger set of actions that are likely to be non-compliant with a set of rules. For example, referring to FIG. 3A, the alternative misconduct 344a “failing to yield at an intersection” may also describe implicit actions that were not described in the initial assessment input 322a. In addition to action 332a “driving through a red light”, the processor 112 may determine that the driver also implicitly failed to yield at an intersection.

Referring to FIG. 3B, for example, the assessment input 322b describes an incident occurring at a specific physical setting, namely, “at the intersection of King St W and Bay.” The processor 112 can determine that a context of the event is an intersection of an urban environment. The initial assessment input 322a also describes the driver as “going at a speed of approximately 100 km/h”. The processor 112 can identify “exceeding the speed limit” as an alternative misconduct 344b, as driving at 100 km/h generally exceeds the speed limit of an urban environment. In another example (not shown), if the context of the event was determined to be on a highway (and all other facts remain the same as initial assessment input 322a), the processor 112 may not identify “exceeding the speed limit” as an alternative misconduct, as driving 100 km/h is generally at the speed limit for a highway (i.e., for the relevant jurisdiction).

In some embodiments, the assessment system 110 can identify one or more alternative misconducts legally similar to the set of misconducts within a context of the event associated with the one or more behaviors.

Referring to FIG. 2, at 240, the processor 112 provides one or more rules 352 violated by the set of misconducts 342 and the one or more alternative misconducts 344.

Referring to FIG. 3A, the rules field 350 provides one or more rules 352 provided by the processor 112.

In some embodiments, providing one or more rules can include displaying the one or more rules 352 on a graphical interface such as dashboard 310 shown in user interface 300. Although the one or more rules 352 shown in FIG. 3A is displayed in a tabular format, it will be understood that the one or more rules 352 can be displayed using any suitable format.

In some embodiments, providing one or more rules can include identifying one or more organizational components of the one or more rules. For example, the provided one or more rules 352 can include organizational components 354 such as but not limited to a section, an authority, and one or more descriptions. Organizational components 354 can be generated by the processor 112. For example, in some embodiments, the processor 112 can generate a summarized description of the one or more rules (e.g., a short description or a long description). Organizational components 354 can also be extracted by the processor 112 from metadata associated with the source from which the rule was retrieved (e.g., from a regulatory database, or an Internet database).

In some embodiments, the provided one or more rules can also include a relevance level based on the one or more behaviors within a context of the event. For example, referring to FIG. 3C, the provided rule 352b can be a law from section 128(1) of Ontario's Highway Traffic Act describing a provision related to a “motor vehicle operating above the posted speed limit”. The processor 112 can determine the provided rule 352b as having a “high” relevance based on the identified behaviors within a context of the event. The derived behavior related to the observed action 332b “driving at high speeds” may be defined by the processor 112 as “aggressive”. The processor 112 can also consider the context of the event, namely, driving at 100 km/h in an urban environment. Based on the derived behavior within the context of the event, the processor 112 may determine provided rule 352b has a “high” relevance level.

As another example, provided rules 352c and 352d can be laws from sections 320.13 and 320.14 of the Criminal Code of Canada describe provisions related to “dangerous driving” and “impaired driving” respectively. The processor 112 can determine provided rules 352c and 352d as having a “medium” and “low” relevance level, respectively, based on the identified behaviors within a context of the event. The derived behavior related to observed action 332c “making erratic lane switches” may be defined by the processor 112 as “erratic”. The processor 112 can also consider the context of the event, namely, driving in an urban environment and/or avoiding other vehicles. Based on the derived behavior within the context of the event, the processor 112 can determine provided rules 352c and 352d have a “medium” and “low” relevance level, respectively. The processor 112 may not consider an “erratic” behavior while driving to be highly relevant and/or indicative of “dangerous driving” or “impaired driving” within the scope of provided rules 352c and 352d, respectively.

The one or more rules can be sorted to be viewed based on any of the organizational components or the relevance factor.

In some embodiments, providing one or more rules can include receiving a user profile. The user profile may be, for example, for an enforcement officer. The user profile may include attributes unique to the enforcement officer such as but not limited to a name, a badge number, a rank, and a department.

The user profile can also include a geographical location indicating where the enforcement officer is stationed. In some embodiments, the processor 112 may filter the one or more rules provided based on the user profile to provide one or more localized rules associated with the geographical location. For example, the geographical location provided in the user profile may indicate that an enforcement officer is stationed in Ontario, Canada. The processor 112 may provide rules only associated with Ontario, Canada, and filter laws associated with other jurisdictions.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

We claim:

1. A method for automatically determining non-compliance from an initial assessment input describing an event in a natural language format, the method comprising operating a processor to:
apply an event assessment data model to the initial assessment input to identify one or more actions observed and to derive one or more behaviors related to the observed one or more actions;
apply a behavioral assessment data model to select a set of misconducts from the one or more actions, the set of misconducts comprising the one or more actions likely to be non-compliant with a set of rules;
identify one or more alternative misconducts semantically similar to the set of misconducts within a context of the event associated with the one or more behaviors; and
provide one or more rules violated by the set of misconducts and the one or more alternative misconducts.

2. The method of claim 1, wherein operating the processor further comprises:
determining one or more legal infractions from the initial assessment input, and the set of misconducts comprising one or more actions likely to infringe a law.

3. The method of claim 1, wherein operating the processor further comprises:
identifying one or more alternative misconducts legally similar to the set of misconducts within a context of the event associated with the one or more behaviors.

4. The method of claim 1, wherein operating the processor to apply the event assessment data model further comprises:
identifying, from the initial assessment input, a regional dialect comprising one or more geographically-specific phrases; and
assessing the initial assessment input by considering the regional dialect to determine one or more semantic actions of the identified one or more actions and to derive one or more behaviors.

5. The method of claim 1, wherein operating the processor to apply the event assessment data model further comprises:
generating an unbiased initial assessment input, the unbiased initial assessment input absent one or more profiling descriptors.

6. The method of claim 1, wherein operating the processor to apply the behavioral assessment data model further comprises:
generating a search vector comprising the one or more actions likely to be non-compliant with a set of rules and the one or more derived behaviors.

7. The method of claim 1, wherein operating the processor to apply the behavioral assessment data model further comprises:
evaluating the one or more actions likely to be non-compliant with a set of rules to determine an infringement confidence level.

8. The method of claim 1, wherein operating the processor to apply the behavioral assessment data model further comprises:
identifying from a database one or more regulatory sources associated with the one or more actions; and
filtering one or more sections from the one or more regulatory sources based on the one or more behaviors.

9. The method of claim 1, wherein operating the processor to provide one or more rules further comprises:
receiving a user profile, the user profile comprising at least a geographical location; and
filtering the one or more rules based on the user profile to provide one or more localized rules associated with the geographical location.

10. The method of claim 1, wherein operating the processor to provide one or more rules further comprises:
identifying one or more organizational components of the one or more rules;
generating a summarized description of the one or more rules; and
determining a relevance level for the one or more rules based on the one or more behaviors within a context of the event.

11. The method of claim 1, wherein operating the processor to provide one or more rules further comprises:
displaying the one or more rules on a graphical interface.

12. An assessment system for automatically determining non-compliance from an initial assessment input describing an event in a natural language format, the system comprising:
a data storage comprising an event assessment data model operable for identifying one or more actions from an input in the natural language format, and a behavioral assessment data model operable for identifying misconducts from the one or more actions; and a processor in communication with the data storage, the processor being operable to:
apply the event assessment data model to the initial assessment input to identify one or more actions observed and to derive one or more behaviors related to the observed one or more actions;
apply the behavioral assessment data model to select a set of misconducts from the one or more actions, the set of misconducts comprising the one or more actions likely to be non-compliant with a set of rules;
identify one or more alternative misconducts semantically similar to the set of misconducts within a context of the event associated with the one or more behaviors; and
provide one or more rules violated by the set of misconducts and the one or more alternative misconducts.

13. The assessment system of claim 12 wherein the processor is further operable to:
determine one or more legal infractions from the initial assessment input, and the set of misconducts comprising one or more actions likely to infringe a law.

14. The assessment system of claim 12 wherein the processor is further operable to:
identify one or more alternative misconducts legally similar to the set of misconducts within a context of the event associated with the one or more behaviors.

15. The assessment system of claim 12, wherein the processor is further operable to:
identify, from the initial assessment input, a regional dialect comprising one or more geographically-specific phrases; and
assess the initial assessment input by considering the regional dialect to determine one or more semantic actions of the identified one or more actions and to derive one or more behaviors.

16. The assessment system of claim 12, the processor further is operable to:
generate an unbiased initial assessment input, the initial assessment input absent one or more profiling descriptors.

17. The assessment system of claim 12, wherein the processor is further operable to:
generate a search vector comprising the one or more actions likely to be non-compliant with a set of rules and the one or more derived behaviors.

18. The assessment system of claim 12, wherein the processor is operable to:
evaluate one or more actions likely to be non-compliant with a set of rules to determine an infringement confidence level.

19. The assessment system of claim 12, wherein the processor is operable to:
identify from a database one or more regulatory sources associated with the one or more actions; and
filter one or more sections from the one or more regulatory sources based on the one or more behaviors.

20. The assessment system of claim 12, wherein the processor is operable to:
receive a user profile, the user profile comprising at least a geographical location; and
filter the one or more rules based on the user profile to provide one or more localized rules associated with the geographical location.

21. The assessment system of claim 12, wherein the processor is operable to:
identify one or more organizational components of the one or more rules;
generate a summarized description of the one or more rules; and
determine a relevance level for the one or more rules based on the one or more behaviors within a context of the event.

22. The assessment system of claim 12, wherein the processor is operable to:
display the one or more rules on a graphical user interface.
